(19) United States
(12) Patent Application Publication
(10) Pub. No.: US 2015/0302819 A1
(43) Pub. Date: Oct. 22, 2015

(54) UPDATING AN ATTRIBUTE USED FOR DISPLAYING VIDEO CONTENT BASED ON VIDEO CONTENT TYPE

(71) Applicant: Lenovo (Singapore) Pte. Ltd., Singapore (SG)

(72) Inventors: Arnold S. Weksler, Raleigh, NC (US); Nathan J. Peterson, Durham, NC (US); Russell Speight VanBlon, Raleigh, NC (US); John Carl Mese, Cary, NC (US)

(73) Assignee: Lenovo (Singapore) Pte. Ltd., Singapore (SG)

(21) Appl. No.: 14/258,199

(22) Filed: Apr. 22, 2014

(51) Int. Cl. G09G 5/00; G06T 5/00

(52) U.S. Cl. CPC G09G 5/001; G06T 5/002; G09G 2320/10

(57) ABSTRACT

An embodiment provides a method, including: receiving, from a video source, video content; determining, using a processor, a type of the video content; the determining being based on data related to the video content; and updating, using a processor, an attribute used by a display to display the video content. Other aspects are described and claimed.

### BACKGROUND

Many displays (e.g., televisions (TVs), computer monitors and the like) are capable of displaying video content using a faster refresh rate (e.g., 120 Hz or 240 Hz and beyond) than the conventional 60 Hz rate. While this has allowed improvements in dealing with certain visual artifacts noticeable to some viewers, e.g., motion blur is reduced in certain fast paced content such as sports; the improvement in smoothing blurred video found via increasing the display's refresh rate has led to a so-called soap opera effect.

The soap opera effect is evident in a fast refresh rate display that applies de-blurring techniques (or other motion smoothing referred to by various trade names, which may include 2:3 de-juddering) such as frame interpolation to certain video content, e.g., lower-frame rate content such as 24 fps (frame per second) films, often found in movies and scripted television shows. This smoothing out of the video content by a fast refresh rate display thus may result in ultra smoothed video being rendered by the display, making it appear as though the content was filmed at a higher frame rate, e.g., 60 fps, such as with a soap opera. This can appear odd to certain viewers that have come to expect a certain visual quality in particular types of video content.

### BRIEF SUMMARY

In summary, one aspect provides a method, comprising: receiving, from a video source, video content; determining, using a processor, a type of the video content; the determining being based on data related to the video content; and updating, using a processor, an attribute used by a display to display the video content.

Another aspect provides an apparatus, comprising: a display device; a processor operatively coupled to the display device; a memory storing instructions executable by the processor to: receive, from a video source, video content; determine a type of the video content based on data related to the video content; and update an attribute used by a display to display the video content.

A further aspect provides a computer program product, comprising: a storage device having code stored therewith and executable by a processor, the code comprising: code that receives, from a video source, video content; code that determines, using a processor, a type of the video content based on data related to the video content; and code that updates, using a processor, an attribute used by a display to display the video content.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of updating an attribute used for displaying video content based on video content type.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Viewers having displays, e.g., televisions or other monitors (particularly LCDs) used for viewing video content, often encounter ultra smoothed video that looks odd because the display is capable of a fast refresh rate (e.g., 120 Hz or greater). This is particularly noticeable in viewing certain types of video content, e.g., movies and television programs such as sitcoms, TV movies, etc. While image or frame interpolation improves video content viewing for certain other content, e.g., sports content, video games, etc., the ultra smoothing or de-blurring of fast refresh capable displays is troublesome to some viewers.

If a viewer encounters this effect, the only recourse is to manually adjust the display settings, e.g., interfacing with a de-blurring interface offered by some display manufacturers. Many viewers cannot even find this interface to adjust the settings, nor are they aware of what the appropriate settings may be for particular types of video content.

Accordingly, an embodiment provides for automatically detecting a video content type and adjusting the display to an appropriate setting for viewing the content. By way of example, an embodiment detects a content type by accessing data, e.g., metadata available and associated with the video content, such as either data embedded within the video content or data available from a different source such as a program guide, and/or data derived from the content itself, e.g., frame data used to match known content, e.g., a sports item in a captured frame such as a football. An embodiment for example may detect content type using the program guide or content metadata to determine a content type or category (e.g. sports, movie, soap opera, sitcom, etc.).

In one example, an embodiment may determine the title of the video content and map the title to a known content type (e.g., film, reality television, sports program, etc.). An embodiment may also determine a content type by accessing information regarding a stream rate of the video content, a resolution of the video content, a compression algorithm(s) used to compress and/or decompress the video content, a frame rate used to capture the video content, a frame capture technique (e.g., 3:2 pull down) used to generate the content, and/or information generally regarding the source of the video content.

When a video type is detected, an embodiment uses this information to adjust or update an attribute (e.g. refresh rate) used by the display to display the video content. In this way, an embodiment allows the display attributes or settings to be modified to be ideal for that particular program. For example, when watching a football game, the refresh rate could be increased to the highest setting for optimal viewing. In contrast, when watching a movie, a refresh rate could be lowered automatically to avoid over/under sampling or the so-called soap opera effect.

The illustrated example embodiments will be best understood by reference to the figures. The following description is intended only by way of example, and simply illustrates certain example embodiments.

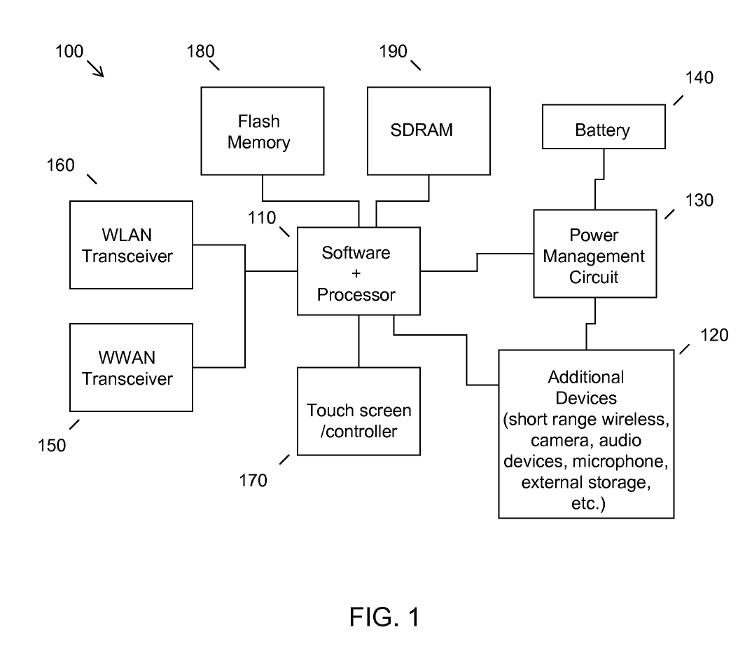

While various other circuits, circuitry or components may be utilized in information handling devices (also referred to herein as apparatuses, electronic devices, or simply devices), with regard to smart phone and/or tablet circuitry 100, an example illustrated in FIG. 1 includes a system on a circuit design found for example in tablet or other mobile computing platforms. Software and processor(s) are combined in a single circuit 110. Processors comprise internal arithmetic units, registers, cache memory, busses, I/O ports, etc., as is well known in the art. Internal busses and the like depend on different vendors, but essentially all the peripheral devices (120) may attach to a single circuit 110. The circuitry 100 combines the processor, memory control, and I/O controller hub all into a single circuit 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single circuit, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. System 100 often includes a touch screen 170 for data input and display/rendering. System 100 also typically includes various memory devices, for example flash memory 180 and SDRAM 190.

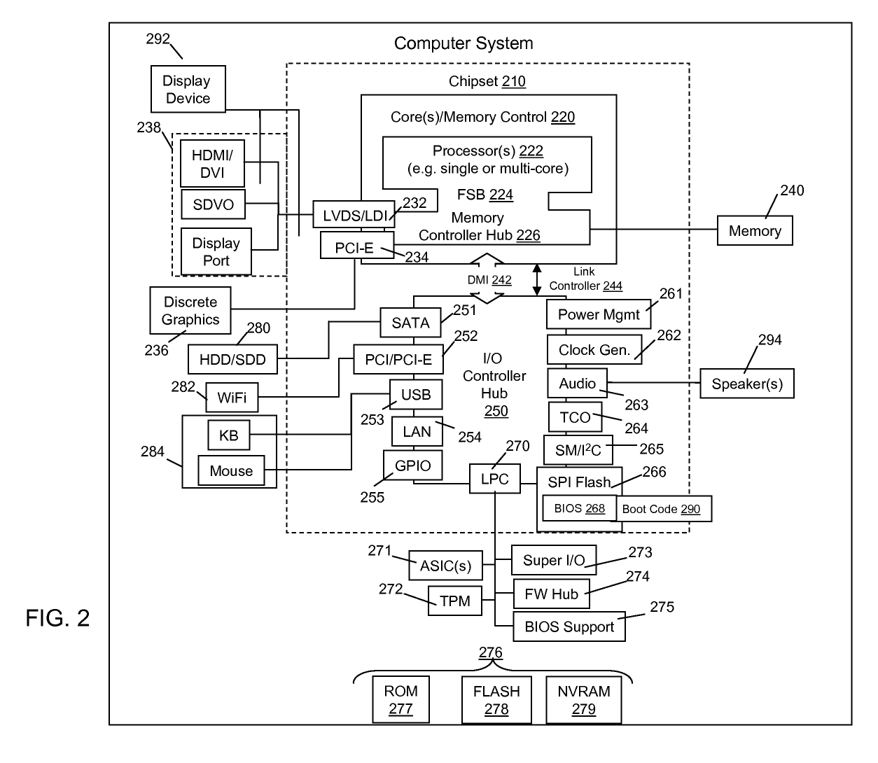

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Circuitry, as for example outlined in FIG. 1 or FIG. 2, may be used to render or display video content, e.g., on an embedded display or a connected (wired or wirelessly) display. In an embodiment, circuitry as outlined in FIG. 1 and FIG. 2 (in part or entirely) may be included in a television or other display monitor that renders or displays video content such as a television show, movie, or the like. The source of the video content may be local, e.g., as read from an optical storage device or other memory device and/or the video source may be a remote device connected operatively to the display, e.g., a television displaying cable derived video content, Internet derived content, or content streamed from another device (e.g., a personal area network device).

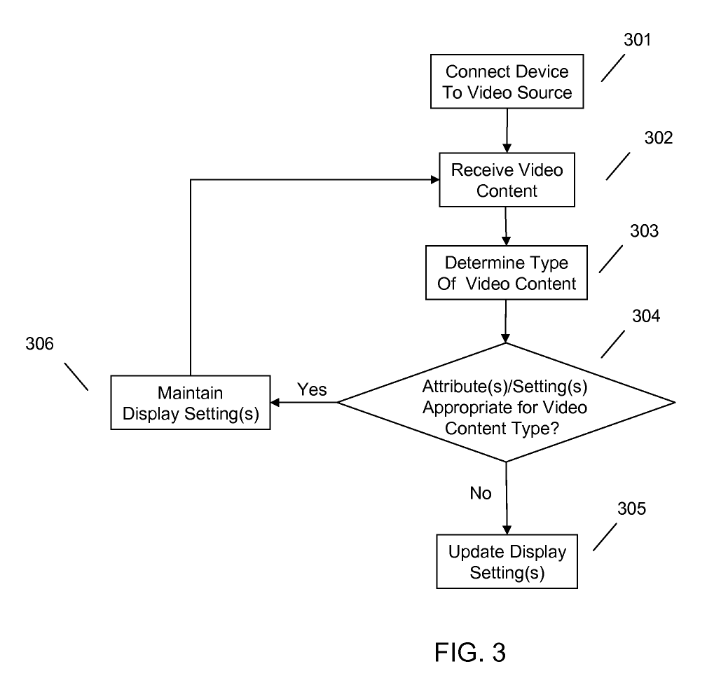

Referring to FIG. 3, an example method of updating an attribute used for displaying video content based on video content type is illustrated. In an embodiment, a device having an integrated display, e.g., a television, or a device operatively coupled to a display, e.g., a set top box, computer or the like, is connect to a video source at 301. As described herein, the video source may be connected through a wired connection or a wireless connection, and the video source may be internal to the device or external thereto, e.g., connected to the device via a network connection.

Having a connection established at 301, an embodiment receives from the video source video content to be rendered or displayed using a display of the device at 302. This may include receiving video content streamed over a network, receiving video content via a set top box connected to a cable distribution network, receiving streamed content via an Internet connection, receiving video content derived from local storage such as an optical disc, etc.

An embodiment may then automatically determine, e.g., using metadata describing the video content in some way, a type of the video content at 303. The determining may be based on metadata associated with the video content. For example, an embodiment may detect content type by accessing program guide information to determine the content is of a predetermined category, e.g., sports, movie, soap opera, other scripted television program, etc. An embodiment may also use other metadata, e.g., stream rate, resolution quality, compression algorithm information, frame rate, etc., to determine a type or category of the video content.

An embodiment may then utilize the content type to map attribute(s) or setting(s) of the display to appropriately display the particular type of content. For example, an embodiment may determine, e.g., based on the type of video content determined in 303, if a current setting or attribute such as refresh rate is appropriate at 304. If not, an embodiment may adjust or update the attribute or setting at 305 to appropriately match the video content being displayed. For example, an embodiment may update an attribute such as refresh rate used by a display of the device to display the video content.

In this way, an embodiment may estimate a refresh rate appropriate for displaying the video content based on the type of the video, e.g., where the estimate is derived from the metadata. Thus, if the type of the video is of the category movies, e.g., based on the title or program guide, feature length running time, etc., an embodiment may decrease a refresh rate, e.g., from 120 Hz or 240 Hz to 60 Hz. Similarly, if a user simply switches a channel or loads another video source that is determined to be of a sports category, an embodiment may increase the refresh rate automatically at 305.

If an embodiment determines that the refresh rate is appropriate for the video content being displayed at 305, the settings may be maintained at 306. An embodiment may operate transparently to the user or may further provide an indication of the updating (or lack thereof). For example, an embodiment may notify the user that the refresh rate has been updated or adjusted automatically, e.g., by using a visual or audible notification. An embodiment may further provide a user interface to reverse, confirm or modify the updating as desired. For example, an embodiment may automate the presentation of a user interface via which a user may modify, reverse or confirm the updating such that the user's experience is appropriately customized.

Accordingly, an embodiment provides for automatically updating an attribute used to display video, including (but not limited to) automatically updating the refresh rate, such that the display of video content is matched to the video content type. An embodiment need not match the determination of the video content type to a particular connection or input port. That is, the determining a type of the video content may proceed without reference to a connection type used for establishing a connection between the device and the video source, e.g., as described herein via use of metadata associated with the video content. This streamlines and in fact automates the updating or adjustment of display settings including refresh rate to match the video content being consumed.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, from a video source, video content;
determining, using a processor, a type of the video content;
the determining being based on data related to the video content; and
updating, using a processor, an attribute used by a display to display the video content.

2. The method of claim 1, wherein the attribute comprises a refresh rate.

3. The method of claim 1, wherein the updating comprises estimating a refresh rate for displaying the video content based on the type of the video derived from the data.

4. The method of claim 3, wherein the data is selected from the group of data consisting of program guide information, stream rate information, resolution information, compression technique information, frame rate information, video source information, and one or more frames of the video content.

5. The method of claim 4, wherein the type of the video is selected from the group consisting of movies, sports, user specified content, and standard television programs.

6. The method of claim 5, wherein:
the attribute comprises a refresh rate; and
the updating comprises decreasing the refresh rate to match the type of the content.

7. The method of claim 1, further comprising providing an indication of the updating.

8. The method of claim 7, further comprising providing a user interface to modify the updating.

9. The method of claim 1, wherein the determining a type of the video content proceeds without reference to a connection type used for establishing a connection between the display and the video source.

10. An apparatus, comprising:
a display device;
a processor operatively coupled to the display device;
a memory storing instructions executable by the processor to:
receive, from a video source, video content;
determine a type of the video content based on data related to the video content; and
update an attribute used by a display to display the video content.

11. The apparatus of claim 10, wherein the attribute comprises a refresh rate.

12. The apparatus of claim 10, wherein to update comprises estimating a refresh rate for displaying the video content based on the type of the video derived from the data.

13. The apparatus of claim 13, wherein the data is selected from the group of data consisting of program guide information, stream rate information, resolution information, compression technique information, frame rate information, video source information, and one or more frames of the video content.

14. The apparatus of claim 13, wherein the type of the video is selected from the group consisting of movies, sports, user specified content, and standard television programs.

15. The apparatus of claim 14, wherein:
the attribute comprises a refresh rate; and
to update comprises decreasing the refresh rate to match the type of the content.

16. The apparatus of claim 10, wherein the instructions are further executable by the processor to provide an indication of the update.

17. The apparatus of claim 16, wherein the instructions are further executable by the processor to provide a user interface to modify the updating.

18. The apparatus of claim 10, wherein to determine a type of the video content proceeds without reference to a connection type used for establishing a connection between the display and the video source.

19. The apparatus of claim 10, further comprising a device to which the display is operatively connected.

20. A computer program product, comprising:
a storage device having code stored therewith and executable by a processor, the code comprising:
code that receives, from a video source, video content;
code that determines, using a processor, a type of the video content based on data related to the video content; and
code that updates, using a processor, an attribute used by a display to display the video content.
